(19) United States
(12) Patent Application Publication
(10) Pub. No.: US 2023/0128872 A1
(43) Pub. Date: Apr. 27, 2023

(54) A FIXED COLOR IMAGE INCLUDING PIXELS AND METHOD OF MAKING THE COLOR IMAGE

(71) Applicant: VIAVI SOLUTIONS INC., San Jose, CA (US)

(72) Inventors: Cornelis Jan DELST, Fairfax, CA (US); Vladimir P. RAKSHA, Santa Rosa, CA (US); Alberto ARGOITIA, Santa Rosa, CA (US); Paul Thomas KOHLMANN, Windsor, CA (US)

(73) Assignee: VIAVI SOLUTIONS INC., San Jose, CA (US)

(21) Appl. No.: 17/507,558

(22) Filed: Oct. 21, 2021

(51) Int. Cl. H04N 1/60; H04N 1/409

(52) U.S. Cl. CPC H04N 1/6077; H04N 1/409

(57) ABSTRACT

A recorded and fixed color image, including: a plurality of pixels; in which a pixel, of the plurality of pixels, contains two or more additive process color areas; in which each additive process color area, of the two or more additive process color areas, has a centroid located within an area of the pixel; in which locations of the centroids, within the area of the pixel, are present in two or more configurations in the plurality of pixels is disclosed. A method of forming a color image is also disclosed.

### FIELD OF THE INVENTION

The present disclosure generally relates to a recorded and fixed color image, including: a plurality of pixels; in which a pixel, of the plurality of pixels, contains two or more additive process color areas; in which each additive process color area, of the two or more additive process color areas, has a centroid located within an area of the pixel; in which locations of the centroids, within the area of the pixel, are present in two or more configurations in the plurality of pixels. A method for making the color image is also disclosed.

### BACKGROUND OF THE INVENTION

Generally, color images have been recorded with colorants using subtractive color blending, such as cyan, magenta, yellow, and black (CMYK). The subtractive colorants, widely referred to as process colors, are printed in specific pixels with defined colored areas. Ideally, the pixels are printed in perfect register; however, it is more likely than not, that registration errors exist causing an overlap in the subtractive colors. Subtractive colors are generally transparent so that an overlap would still allow transmission of the underlying subtractive color. For this reason, color images produced from subtractive colors are more resilient to registration errors. However, these color images have a limited optical performance because the lightness of the color image is limited by the lightness of the white background, the substrate on which the color image is printed.

Additive colors are opaque by definition and can exhibit a more specular reflection, which could result in improved optical performance. However, if an additive color area is mis-registered relative to where it should be and as a result overlaps with an adjacent additive color area, only the color on top in the overlap would contribute to the color blend, resulting in a color bias within the color image. A registration error is likely to be present in the whole color image or a large area of the color image and the color on top would consistently go over the same adjacent additive color area that is reduced in area as a result. With the likelihood of registration errors during the printing process, additive colors are generally not used to create color images.

Additionally, the registration requirement for using additive colors would make it difficult to create half-tones with a random patterned color area placement size. In particular, color areas generally need to be placed and sized knowing where adjacent color areas are, or will be, to avoid an unintended overlap.

What is needed is a color image with additive colors in which the additive colors are positioned within the pixels to avoid a color bias, in the event of a mis-registration. The size of the additive color areas within a pixel, and/or within a plurality of pixels, can allow for half-tones. Additionally, the additive color areas can be positioned in a random sequence or an encoded sequence to reduce the likelihood of producing a counterfeited color image. Further, the color image can have specular, metallic, light reflection, which cannot be achieved with the use of transparent subtractive colors.

### BRIEF DESCRIPTION OF THE DRAWINGS

Features of the present disclosure are illustrated by way of example and not limited in the following figure(s), in which like numerals indicate like elements, in which:

FIGS. 1, 2, and 3 each illustrate a color image according to an aspect of the invention;

FIG. 4A illustrates a color image with proper registration of the plurality of the pixels;

FIG. 4B illustrate the color image of FIG. 4A with mis-registration of the blue area within of the pixels;

FIG. 5A illustrates a color image with proper registration of the plurality of the pixels;

FIG. 5B illustrates the color image of FIG. 5A with mis-registration of the blue area within the pixels;

FIG. 6A illustrates a color image with proper registration of the plurality of the pixels;

FIG. 6B illustrates the color image of FIG. 6A with mis-registration of blue area within the pixels;

FIG. 7A illustrates a color image with proper registration of the plurality of the pixels;

FIG. 7B illustrates the color image of FIG. 7A with mis-registration of the plurality of the pixels;

FIG. 8 illustrates a color image according to an aspect of the invention; and a blow-up of a portion of the color image illustrating a pattern of the plurality of pixels;

FIG. 9 illustrates a color image according to an aspect of the invention; and a blow-up of a portion of the color image illustrating a pattern of the plurality of pixels; and

FIG. 10 illustrates a color image according to an aspect of the invention; and a blow-up of a portion of the color image illustrating a pattern of the plurality of pixels.

### SUMMARY OF THE INVENTION

In an aspect, there is disclosed a recorded and fixed color image, including: a plurality of pixels; in which a pixel, of the plurality of pixels, contains two or more additive process color areas; in which each additive process color area, of the two or more additive process color areas, has a centroid located within an area of the pixel; and in which locations of the centroids, within the area of the pixel, are present in two or more configurations in the plurality of pixels.

In another aspect, there is disclosed a method of forming a color image, comprising: providing a plurality of pixels; wherein a pixel, of the plurality of pixels, contains two or more additive process color areas; wherein each additive process color area, of the two or more additive process color areas, has a centroid located within an area of the pixel; wherein locations of the centroids, within the area of the pixel, are present in two or more configurations; and overlapping two or more pixels, of the plurality of pixels, wherein the overlap does not result in an average color bias or change of the white balance in the colored image.

Additional features and advantages of various embodiments will be set forth, in part, in the description that follows, and will, in part, be apparent from the description, or can be learned by the practice of various embodiments. The objectives and other advantages of various embodiments will be realized and attained by means of the elements and combinations particularly pointed out in the description herein.

### DETAILED DESCRIPTION OF THE INVENTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, the elements depicted in the accompanying figures may include additional components and some of the components described in those figures may be removed and/or modified without departing from scopes of the present disclosure. Further, the elements depicted in the figures may not be drawn to scale and thus, the elements may have sizes and/or configurations that differ from those shown in the figures.

It is to be understood that both the foregoing general description and the following detailed description are exemplary and explanatory only, and are intended to provide an explanation of various embodiments of the present teachings. In its broad and varied embodiments, disclosed herein are a color image, and a method of making a color image.

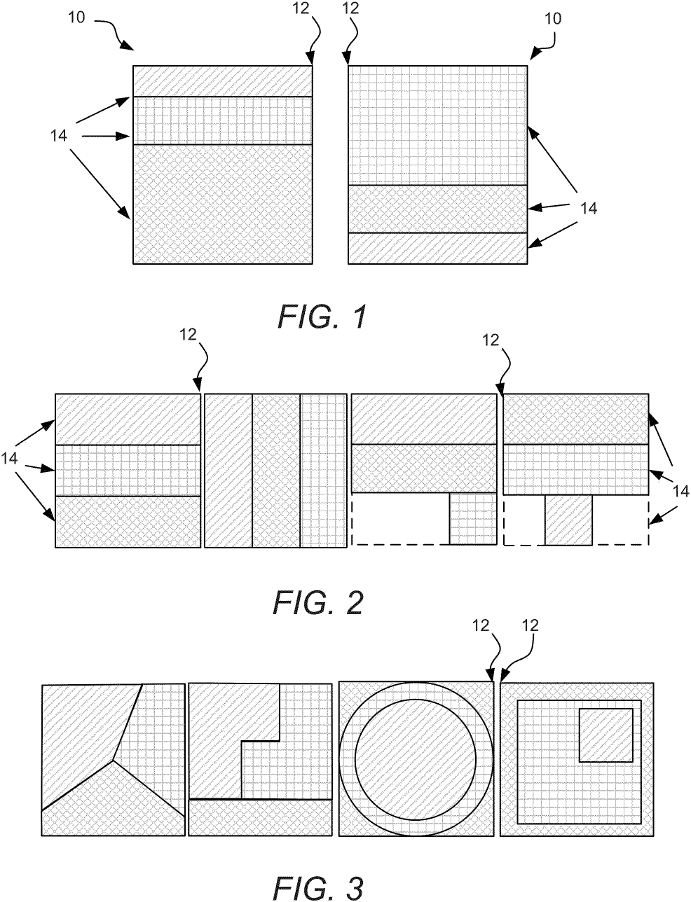

As shown in FIG. 1, a recorded and fixed color image can comprise a plurality of pixels 10; wherein a pixel, of the plurality of pixels, can contain two or more additive process color areas 14; wherein each additive process color area 14, of the two or more additive process color areas, can have a centroid located within an area of the pixel; and wherein locations of the centroids, with the area of the pixel, are present in two or more configurations in the plurality of pixels 10. Each pixel 10 can have a perimeter 12.

The color image can be recorded and fixed on a substrate, such as paper, plastic, glass, etc. By “recorded” it is understood to mean that the color image is set down, for example, printed so the color image can be seen in the future. The color image can be recorded by an electrostatic printing method, but other methods can be used. By “fixed” it is understood to mean that the color image is intended to be permanent for the functional life of the colorants or recording.

The color image can comprise a plurality of pixels 10. The plurality of pixels can be from two or more pixels to an unlimited number of pixels. The number of pixels in the plurality of pixels can vary depending upon the quality/clarity of the color image, wherein a higher quality/clarity color image includes a greater number of pixels as compared to a lower quality/clarity color image. For the sake of simplicity, the color image of FIG. 1 illustrates two pixels 10, in which a first pixel, on the left, is adjacent to a second pixel, on the right. The designations of “first pixel” and “second pixel” are used for ease in explaining the physical locations of pixels 10 within the color image, and are not intended to be limiting. Similarly, the use of the terms “right”, “left”, “top” and “bottom” will be used for ease in explaining physical locations/relationships/designations and are not intended to be limiting.

A color image recorded with additive colorants can be, in general, a combination of three or more additive process colors printed in half-tone, variable size color areas, with the size of the color areas determining the color blend. In general, the number of half-tone dots, or the areas reserved for these half-tone dots can be the same for each process color. An area that comprises one of each and adjacent reserved areas for the additive process colors can be referred to as a pixel. The number of areas reserved for each color can be generally identical and the number of pixels, and the process color areas can be each configured in a fixed pitch matrix with a slight offset between the matrices to make the color areas not overlap. Potential implementations use matrices with variable spacing or no matrix for one or more of the colors and a variable placement of the color areas. The invention does not rely on the use of fixed pitch matrices and pixels. Half-tones can also be achieved with fixed size additive process color areas whereby the color can be determined by the distance between additive process color areas. The invention is illustrated based on the use of pixels. This illustration is not intended as a limitation to the use of matrices or pixels.

A pixel, of the plurality of pixels, can contain two or more additive process color areas 14. An additive process color area 14 is understood to mean an area, within a pixel 10, that can be designated for an additive process color. An additive process color is a color, such as red, green, or blue, that can be combined with at least one other additive process color to produce a plurality of colors including white. In an aspect, a pixel 10 can include one additive process color area 14. For example, the pixel 10 can be red. As shown in FIG. 1, in another aspect, a pixel 10 can include three additive process color areas 14. For example, the pixel 10 can include at least one of red, green, blue, and white color areas. The designations of “first additive process color area” and “second additive process color area” are used for ease in explaining the physical locations of additive process color area 14 within a pixel 10, and are not intended to be limiting. Similarly, the use of the terms “right”, “left”, “top”, “bottom”, and “adjacent” will be used for ease in explaining physical locations/relationships/designations and are not intended to be limiting.

Each additive process color area 14 can be the same or different within a pixel, and within the plurality of pixels, with regard to shape, size, color, and location. As will be discussed in more detail later, a color image that includes a plurality of pixels, in which a portion of the pixels include variations with regard to the additive process color areas 14, can be less likely to exhibit a color bias, and/or can be less likely to be counterfeited. In this manner, the color image can be used in a security document.

As shown in FIG. 1, each pixel 10, with the plurality of pixels, includes two or more additive process color areas 14, for example, three additive process color areas. Each additive process color area 14, of the two or more additive process color areas, can have a same shape. The additive process color areas 14 in FIG. 1 are rectangle shapes, whereas the additive process color areas 14 in some of the pixels 10 of FIG. 3 are a circle or square shape. In another aspect, at least one additive process color area 14, of the two or more additive process color areas, can have a different shape. For example, as shown in FIG. 3, the two left pixels include additive process color areas with different polygon shapes, such as different shaped triangles, “L” shapes, and rectangles.

In an aspect, each additive process color area 14, of the two or more additive process color areas, can have a same size. As shown in FIG. 2, each additive process color area 14 has a same size area with each pixel. For example, starting from the left, the first pixel has three same sized area horizontal rectangles, and the second pixel has three same sized area vertical rectangles. The third and fourth pixels also have three same sized area horizontal rectangles, with the bottom additive process color area 14 indicated by the dashed line. In an aspect, the additive process color area 14, indicated by the dashed line, can be include a reserved area. A reserved area is understood to mean a portion of the additive process color area 14 that does not include a reflective pigment, e.g., is absent a color. A reserved area can be used in a pixel when a smaller amount of an additive process color is needed.

In another aspect, at least one additive process color area 14, of the two or more additive process color areas, can have a different size. As shown in FIG. 1, each additive process color area has different sized rectangle shapes. The right two pixels in FIG. 3 also additive process color areas with different sizes, such as different sized circles or squares.

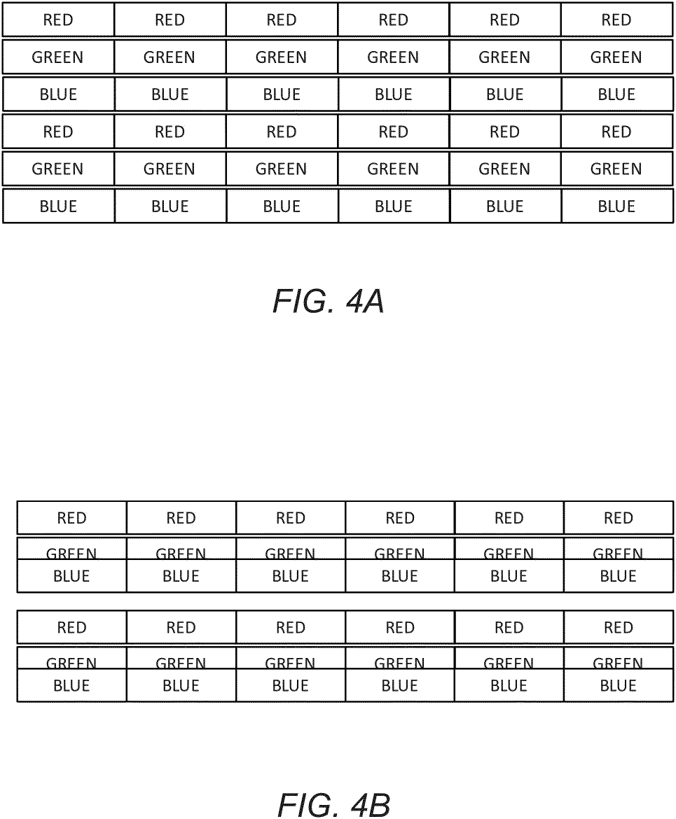

Each additive process color area 14 can have a centroid, which is understood as a center of mass, located with an area of the pixel. The area of the pixel is understood to be a total area including all of the additive process color areas 14, including any reserved areas. A pixel 10 can have two or more additive process color areas 14, and each additive process color area 14 can have a centroid, and wherein locations of the centroids can be present in two or more configurations in the plurality of pixels. As with the variations in the additive process color areas 14 discussed above, varying the locations of the centroids within the area of the pixel can decrease a color bias and/or reproducibility of the color image. In an aspect, the locations of the centroids within the area of the pixel, and/or within the plurality of pixels can be a random or quasi-random sequence. In another aspect, the locations of the centroids within the area of the pixel can encode a predetermined sequence, e.g., the numerical digits for π. Centroids and their locations will be explained more fully with regard to FIGS. 4A-8 below.

Each additive process color area 14 can include a reflective pigment. The reflective pigment can be a metallic pigment, with a metallic reflective layer. The terms “metallic” or “metallic layer” used herein, unless otherwise stated, are intended to include all metals, metal blends and alloys, pure metal or metal alloy containing materials, compound, compositions, and/or layers. The pigment can be opaque. The pigment is not a mica flake coated with titanium dioxide and comprises an opaque pigment, with less than 50% transmission over the visible spectrum. The metallic reflective layer can include metals and/or metal alloys. In one example, any materials that have reflective characteristics can be used. Nonlimiting examples of a material with reflecting characteristics include aluminum, silver, copper, gold, platinum, tin, titanium, palladium, nickel, cobalt, rhodium, niobium, chromium, and compounds, combinations or alloys thereof. Examples of suitable reflective alloys and compounds include bronze, brass, titanium nitride, and the like, as well as alloys of the metals listed above such as silver-palladium. The metallic reflective layer can have an inherent color such as copper, gold, silver copper alloys, brass, bronze, titanium nitride, and compounds, combinations or alloys thereof. The pigment can be encapsulated with a non-conductive layer, such as an organic polymer or metal oxide.

The reflective pigment can be a color shifting pigment. A color shifting pigment can exhibit a first color at a first viewing angle and a second color at a second viewing angle that is different from the first viewing angle. A color shifting pigment can include the following multilayered optical structure: absorber layer/dielectric layer/reflective layer/dielectric layer/absorber layer.

The reflective pigment can be a broad-spectrum reflective pigment. In one example, the materials for the metallic reflective layer can include any materials that have reflective characteristics in the desired spectral range. For example, any material with a reflectance ranging from 50% to 100% in the desired spectral range. An example of a reflective material can be aluminum, which has good reflectance characteristics, is inexpensive, and easy to form into or deposit as a thin layer. Other materials can also be used in place of aluminum. For example, copper, silver, gold, platinum, palladium, nickel, cobalt, niobium, chromium, tin, and combinations, blends or alloys of these or other metals can be used as reflective materials. In an aspect, the material for the reflector layer can be a white or light colored metal. In other examples, the reflector layer can include, but is not limited to, the transition and lanthanide metals and combinations thereof; as well as metal carbides, metal oxides, metal nitrides, metal sulfides, a combination thereof, or mixtures of metals and one or more of these materials.

An amount of the reflective pigment in each additive process color area can be the same. For example, as shown in FIG. 2, each additive process color area 14 in the left pixel has a same amount of reflective pigment in each of the three additive process color areas. In another aspect, an amount of the reflective pigment in at least one additive process color area is different. For example, as shown in FIG. 2, the bottom additive process color area 14 has a different amount of reflective pigment as compared to the middle and top additive process color areas 14. In this instance, the additive process color area 14 can include a reserved area, which has an absence of reflective pigment or color, and an area with an amount of reflective pigment. A portion of the pixels, of the plurality of pixels, can include a reserved area that is absent a color.

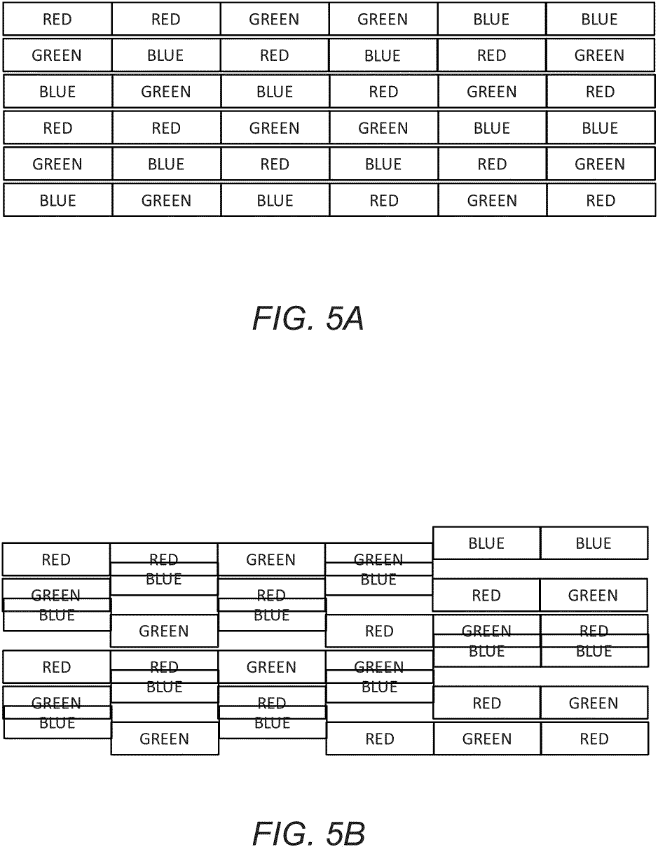

Each additive process color area, within a first pixel, can be present in a first sequence. Each additive process color area, within a second pixel, can be present in a second sequence. As shown in FIG. 4A, the first sequence (red/green/blue) can be the same as the second sequence (red/green/blue). As shown in FIG. 5A, the first sequence (red/green/blue of top left pixel) can be the same as the second sequence (red/blue/green of the adjacent top pixel).

An additive process color area 14, within a pixel, and/or with a portion of a plurality of pixels, can provide a same level of color performance as another additive process color area 14. If there is a same level of color performance, then a size of an additive process color area 14 is likely the same. In an aspect, an additive process color area 14 can have a bigger sizer for a weaker performing color. Similarly, an additive process color area can have a smaller size for a stronger performing color. The inclusion of various sized and/or shaped additive process color areas 14 in a pixel, and/or with a portion of the plurality of pixels, can result in a white balance in the color image.

FIG. 4A illustrates a color image with a plurality of pixels. Each pixel has three additive process color areas. As an example, the top left pixel has a first additive process color, which is red, a second additive process color area which is green, and a third additive process color area which is blue. The additive process color areas, have the same size, shape, and amount of reflective pigment within each additive process color area. The additive process color areas are in a same sequence in each pixel, and within the plurality of pixels. The centroids of each additive process color area are similarly located in a single configuration with the plurality of pixels. Each pixel is in register with its adjacent pixel (top, bottom, left, ride) so that a portion of a perimeter a pixel does not overlap with a portion of a perimeter of an adjacent pixel. In an ideal electrophotographic printing process, a color image would include registered pixels, as shown in FIG. 4A.

However, in a high volume printing process, for example, during printing of banknotes, perfect registration of pixels is not likely. Instead, it is more likely, that there would be a printing error, such as mis-registration. FIG. 4B illustrates a color image wherein a centroid of each additive process color area for blue in each pixel was mis-registered with an adjacent additive process color for green. In particular, the two or more additive process color areas, of a pixel, can be a first additive process color area (blue) and a second additive process color area (green), in which the first additive process color area (blue) overlaps the second additive process color area (green). There is an image-wide loss of green and a gain of blue, as compared to the color image of FIG. 4A, which does not include a registration error.

FIG. 5A illustrates a color image including a plurality of pixels, wherein a first pixel, of the plurality of pixels, includes two or more additive process color areas (red/green/blue); and a second pixel, adjacent to the first pixel, includes two or more additive process color areas (red/blue/green). A sequence of the two or more additive process color areas is different in at least two pixels, of the plurality of pixels. For example, each pixel in a first position (column) has a first sequence of additive process color areas (red/green/blue), each pixel in a second position (column) has a second sequence of additive process color areas (red/blue/green), etc. So, the color image includes a plurality of pixels; wherein a first portion of pixels, of the plurality of pixels, contain two or more additive process color areas in a same first sequence; and wherein a second portion of pixels, of the plurality of pixels, contain two or more additive process color areas in a same second sequence; wherein the first sequence is different from a second sequence. The pixels in the color image are in register and do not exhibit any average color bias or change of the white balance.

FIG. 5B illustrates the color image of FIG. 5A with a registration error so that a centroid of each blue additive process color area is shifted upward within each pixel, and/or with the plurality of pixels. Each additive process color area (red, green, blue) has a centroid located within an area of the pixel, in which locations of the centroids, within the area of the pixel, can be present in two or more configurations in the plurality of pixels. For example, looking at the top left pixel (red/green/blue), its adjacent top pixel (red/blue/green), and the next adjacent top pixel (green/red/blue) it can be seen that the locations of the centroids are present in 2 or more configurations in the plurality of pixels. In particular, the locations of the centroids in the green/blue top left pixel, are in a different configuration as compared to the locations of the centroids red/blue in the adjacent top pixel, and as compared to the locations of the centroids red/blue in the next adjacent top pixel. As can be seen, there is still an image-wide gain in blue, but the loss of the other colors, red and green, is shared across the color image. So, even though the color image includes a registration error or overlap, the color image contains less of a color bias towards blue as compared to the color image of FIG. 4B. The colors applied before the one on top are impacted by the overlap due to mis-registration. The decreased color bias can be attributed to the locations of the centroids being present in two or more configurations in the plurality of pixels. This can enable varying the sequences of the additive process color areas in each pixel, and/or within the plurality of pixels.

As discussed above, FIG. 4B illustrates a registration error within a pixel, i.e., an overlap between two or more adjacent additive process color areas within a pixel. The left four columns of FIG. 5B also illustrates the same registration error within a pixel. However, the right two columns of FIG. 5B illustrate a registration error between adjacent pixels, e.g., a top pixel and a bottom pixel, within the plurality of pixels. For example, the top right pixel (blue/green/red) overlapped with the below right pixel (blue/green/red). In particular, an additive process color area (red) of a first pixel (blue/green/red) overlapped with an additive process color area (blue) of a second pixel (blue/green/red).

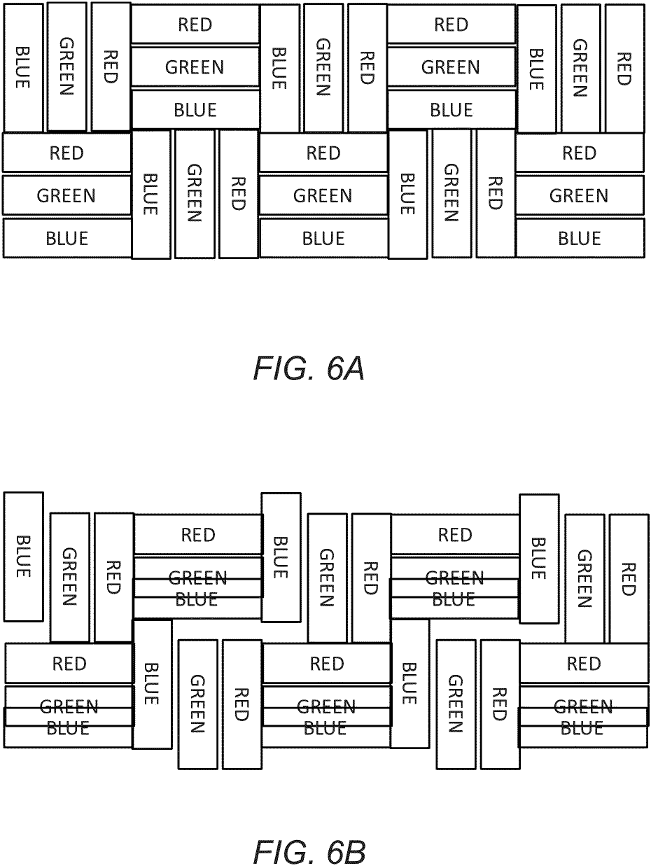

FIG. 6A illustrates a color image in which each pixel, of the plurality of pixels, includes two or more additive process color areas (red, green, blue). The additive process color areas are the same shape, within a pixel, and within the plurality of pixels. The additive process colors are in a same sequence (red/green/blue) within a pixel, and within the plurality of pixels. Each additive process color area has a centroid, and the locations of the centroids are present in two or more configurations in the plurality of pixels. For example, a first portion of pixels, of the plurality of pixels, are configured with the centroids of each additive process color areas in a horizontal position; and a second portion of pixels, of the plurality of pixels, are configured with the centroids of each additive process color areas in a vertical position. The pixels in the color image are in register and do not exhibit any color bias.

FIG. 6B illustrates the color image of FIG. 6A with a registration error so that a centroid of each blue additive process color area is shifted upward within each pixel, and/or with the plurality of pixels. Similar, to FIG. 5B, there is still an image-wide gain in blue, but the loss of the other colors, red and green, is shared across the color image. So, even though the color image includes a registration error or overlap, the color image contains less of a color bias towards blue as compared to the color image of FIG. 4B. The decreased color bias can be attributed to the locations of the centroids being present in two or more configurations in the plurality of pixels. This can enable varying the sequences of the additive process color areas in each pixel, and/or within the plurality of pixels.

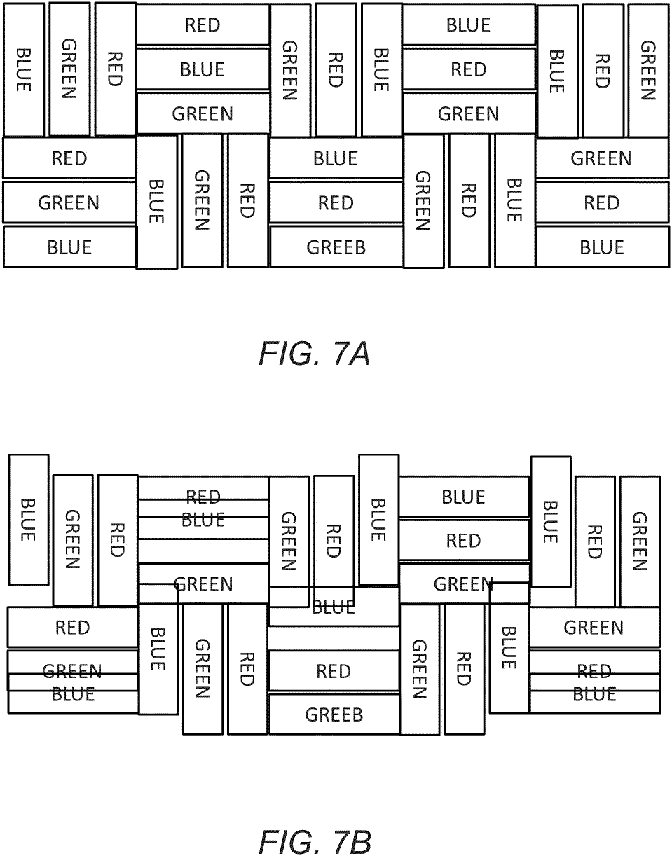

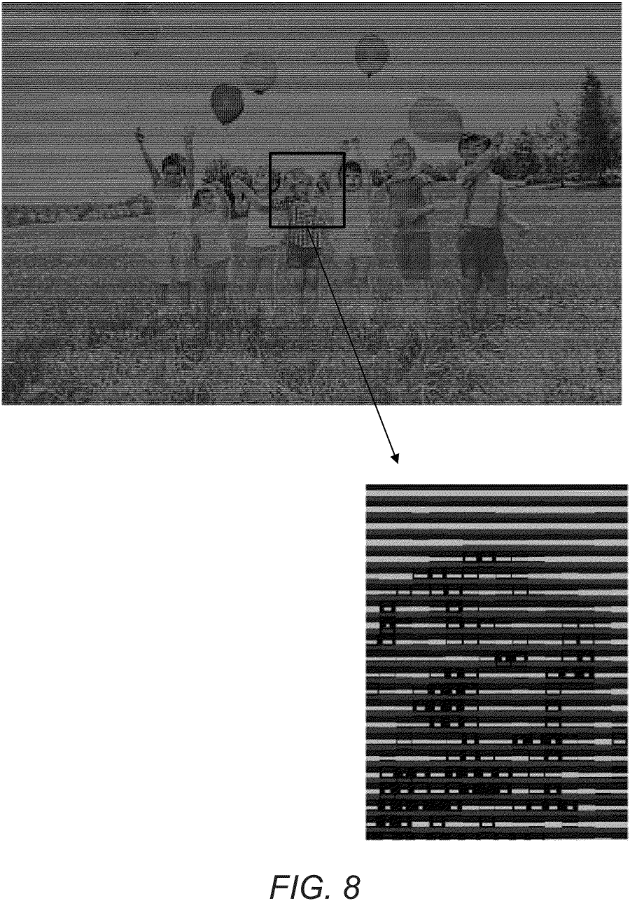

FIG. 7A is similar to FIG. 6A, except that a sequence of the two or more additive process color areas is different in at least two pixels, of the plurality of pixels. For example, a first pixel in a first position has a first sequence of additive process color areas (red/green/blue) in a first centroid configuration (e.g., vertical), a second pixel in a second position has a second sequence of additive process color areas (red/blue/green) in a second centroid configuration (e.g., horizontal), etc. The pixels in the color image are in register and do not exhibit any color bias.

FIG. 7B illustrates the color image of FIG. 7A with a registration error so that a centroid of each blue additive process color area is shifted upward within each pixel, and/or with the plurality of pixels. The color image includes a pixel having a perimeter that overlaps with a portion of a perimeter of an adjacent pixel. For example, referring to the second column from the left, the top pixel includes additive process color areas (red/blue/green) with a centroid of each additive process color area in a horizontal configuration; and the bottom pixel includes additive process color areas (red/green/blue) with a centroid of each additive process color area in a vertical configuration (with the blue additive process color area additionally shifted upward). The bottom pixel has a perimeter that overlaps with a portion of a perimeter of the adjacent top pixel. In particular, a portion of perimeter of the bottom pixel that defines the blue additive process color area overlaps with a portion of the perimeter of the top pixel that defines the green additive process color area.

The locations of the centroids within the area of a pixel form a random or quasi-random sequence. The combination of different configurations of centroids (e.g., vertical/horizontal) and different sequence of additive process color areas decreased a color bias in the color image.

FIG. 8 illustrates a color image similar to the color image of FIG. 4A. As can be seen in the blow-up of a portion of the color image, the plurality of pixels contains two or more additive process color areas, wherein the locations of the centroids, of the additive process color areas, within an area of the pixel are present in a single configuration. A sequence of the two or more additive process color areas within each pixel and within the plurality of the pixels is the same.

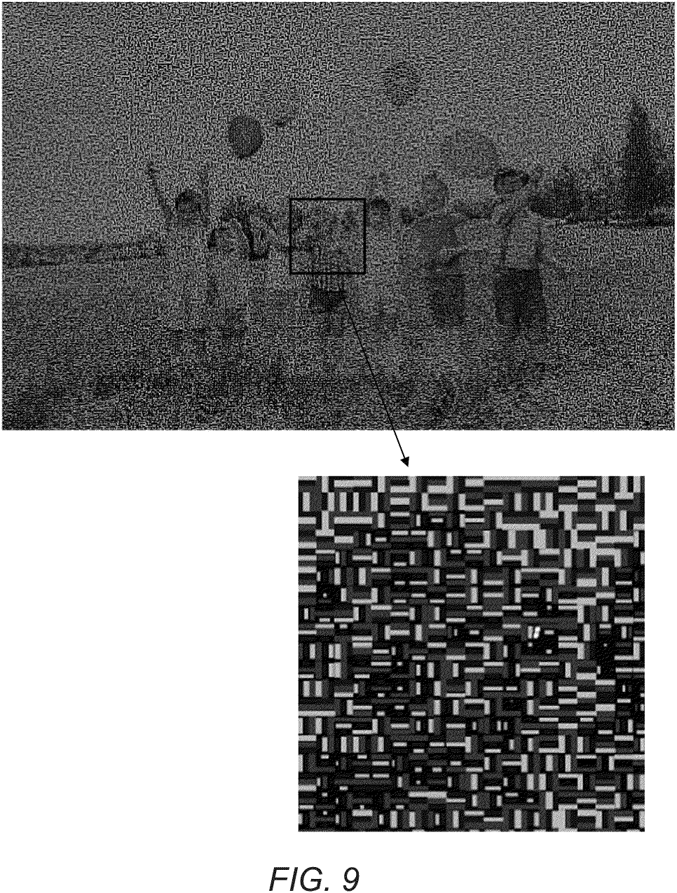

FIG. 9 illustrates a color image similar to the color images of FIGS. 6B and/or 7B .

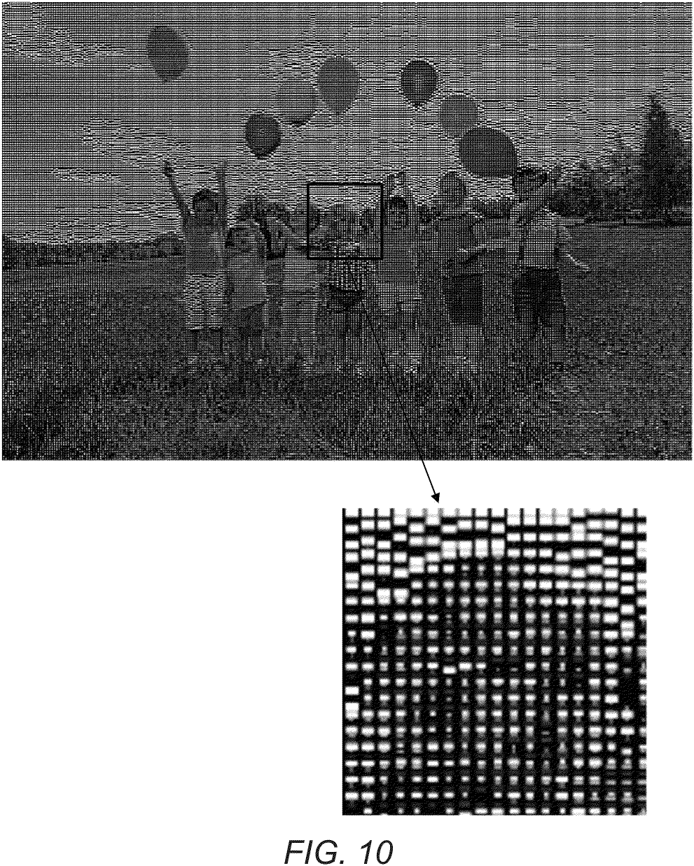

FIG. 10 illustrates a color image similar to the color images of FIGS. 4A and 4B whereby in addition to red green, and blue, a broad spectrum reflective color (representing as white) is used in the additive process color area 14 of a portion of the pixels.

There is also disclosed a method of forming a color image, including providing a plurality of pixels; wherein a pixel, of the plurality of pixels, contains two or more additive process color areas; wherein each additive process color area, of the two or more additive process color areas, has a centroid located within an area of the pixel; wherein locations of the centroids, within the area of the pixel, are present in two or more configurations; and overlapping two or more pixels, of the plurality of pixels, wherein the overlap does not result in a local color bias in the colored image. In this manner, the color image would not include induced fishbone-like patterns or line artifacts. Any repetitive pattern in the variation of centroid location can result in induced line artifacts or fishbone-like patterns as the similar pixels form a color pattern in the matrix. The color location within the pixels can be enough to cause this. This forming of these visible patterns, showing as lines of fishbone like structures, is eliminated, reduced to image noise, by using a random or quasi random sequence without significant repetitive patterns.

The step of providing can including aligning the plurality of pixels in a configuration so as to form a color image. For example, the step of providing can include recording the plurality of pixels in an aligned configuration to form a color image. A first additive process color area of a pixel can be printed, subsequently followed by a second additive process color area of the same pixel. The additive process color areas can be sequentially printed until an entire pixel has been provided.

In an aspect, the step of providing can include increasing a size of an additive process color area, within a pixel, for a reflective pigment that exhibits poor color performance. The step of providing can include decreasing a size of an additive process color area, within a pixel, for a reflective pigment that exhibits poor color performance.

In an aspect, the step of providing can include changing a shape of an additive process color area, within a pixel, relative to the other, of the two or more additive process color area.

In an aspect, the step of providing can include changing the location of the centroid in an additive process color area in a first pixel relative to the location of the centroid in a same additive process color area in an adjacent second pixel.

In an aspect, the step of providing an include changing a sequence of the two or more additive process color areas in a first pixel relative to a different sequence of two or more additive process color areas in a second adjacent pixel.

The step of overlapping can include overlapping a portion of a perimeter of a first pixel with a portion of a perimeter of an adjacent second pixel. For example, a first additive process color of a first pixel can overlap with a portion of a second additive process color of a second adjacent pixel, within the plurality of pixels. In another aspect, a first additive process color can overlap with a second additive process color within a pixel. The overlap can reduce a white balance change of the colored image when the overlap is smaller than a dimension of the pixel. The step of overlapping can be in one direction of the color image, e.g., an overlap upward. The step of overlapping can be in two directions of the color image, e.g., an overlap upward and to the right. The step of overlapping can be random throughout the color image.

In the method, the plurality of pixels is not configured in a repetitive pattern, matrix or raster. Instead, the plurality of pixels can be aligned in a random sequence.

From the foregoing description, those skilled in the art can appreciate that the present teachings can be implemented in a variety of forms. Therefore, while these teachings have been described in connection with particular embodiments and examples thereof, the true scope of the present teachings should not be so limited. Various changes and modifications can be made without departing from the scope of the teachings herein.

This scope disclosure is to be broadly construed. It is intended that this disclosure disclose equivalents, means, systems and methods to achieve the devices, activities and mechanical actions disclosed herein. For each device, article, method, mean, mechanical element or mechanism disclosed, it is intended that this disclosure also encompass in its disclosure and teaches equivalents, means, systems and methods for practicing the many aspects, mechanisms and devices disclosed herein. Additionally, this disclosure regards an article and its many aspects, features and elements. Such an article can be dynamic in its use and operation, this disclosure is intended to encompass the equivalents, means, systems and methods of the use of the device and/or optical device of manufacture and its many aspects consistent with the description and spirit of the operations and functions disclosed herein. The claims of this application are likewise to be broadly construed. The description of the inventions herein in their many embodiments is merely exemplary in nature and, thus, variations that do not depart from the gist of the invention are intended to be within the scope of the invention. Such variations are not to be regarded as a departure from the spirit and scope of the invention.

1. A color image, comprising:
a plurality of pixels recorded and fixed on a substrate;
wherein two or more pixels, of the plurality of pixels, each contain two or more additive process color areas, the two or more additive process color areas each comprising an opaque pigment;
wherein each additive process color area, of the two or more additive process color areas, has a centroid located within an area of the two or more pixels;
wherein locations of the centroids, within the area of each of the two or more pixels, are present in two or more configurations in the plurality of pixels; and
wherein if the two or more pixels each include a registration error that results in an overlap of a first additive process color area onto an adjacent second additive process color area, then the color image exhibits a decreased color bias if compared to a comparative color image that is the same as the color image except that the centroids are present in a single configuration in the plurality of pixels.

2. The color image of claim 1, wherein the locations of the centroids within the area of the two or more pixels is a random or quasi-random sequence.

3. The color image of claim 1, wherein the locations of the centroids within the plurality of pixels is a random or quasi-random sequence.

4. A color image, comprising:
a plurality of pixels recorded and fixed on a substrate;
wherein two or more pixels, of the plurality of pixels, each contain two or more additive process color areas;
wherein each additive process color area, of the two or more additive process color areas, has a centroid located within an area of the two or more pixels; and
wherein locations of the centroids, within the area of each of the two or more pixels, are present in two or more configurations in the plurality of pixels;
wherein the locations of the centroids within the area of the two or more pixels are positioned in an encoded sequence.

5. The color image of claim 1, wherein each additive process color area, of the two or more additive process color areas, has a same shape.

6. The color image of claim 1, wherein at least one additive process color area, of the two or more additive process color areas, has a different shape.

7. The color image of claim 1, wherein each additive process color area, of the two or more additive process color areas, has a same size.

8. The color image of claim 1, wherein at least one additive process color area, of the two or more additive process color areas, has a different size.

9. The color image of claim 1, wherein a pixel of the two or more pixels has a perimeter that overlaps with a portion of a perimeter of an adjacent pixel.

10. The color image of claim 1, wherein
the first additive process color area overlaps the second additive process color area.

11. The color image of claim 1, wherein the opaque pigment is a reflective pigment.

12. (canceled)

13. (canceled)

14. The color image of claim 1, wherein a portion of the pixels, of the plurality of the pixels, also includes a reserved area that is absent a color.

15. A method of forming a color image, comprising:
recording a plurality of pixels on a substrate;
wherein two or more pixels, of the plurality of pixels, each contain two or more additive process color areas, the two or more additive process color areas each comprising an opaque pigment;
wherein each additive process color area, of the two or more additive process color areas, has a centroid located within an area of the two or more pixels;
wherein locations of the centroids, within the area of each of the two or more pixels, are present in two or more configurations in the plurality of pixels; and
wherein if the two or more pixels each including a registration error that results in an overlap of a first additive process color area onto an adjacent second additive process color area, then the color image exhibits a decreased color bias if compared to a comparative color image that is the same as the color image except that the centroids are present in a single configuration in the plurality of pixels.

16. The method of claim 15, wherein the colored image does not include induced fishbone-like patterns or line artifacts.

17. The method of claim 15, wherein the plurality of pixels is not configured in a repetitive pattern, matrix or raster.

18. The method of claim 15, wherein the overlap reduces a white balance change of the colored image .

19. The method of claim 15, wherein the overlapping is in one direction of the color image.

20. The method of claim 15, wherein the overlapping is random throughout the color image.

21. The method of claim 15, further comprising overlapping the two or more pixels, of the plurality of pixels, wherein the overlap does not result in an average color bias or change of the white balance in the colored image.

22. The method of claim 15, wherein the two or more pixels each include a registration error that results in an overlap of a first additive process color area onto an adjacent second additive process color area, the first additive process color area being in a first pixel of the two or more pixels and the adjacent second additive process color area being in a second pixel that is adjacent to the first pixel.

23. A color image, comprising:
a plurality of pixels recorded and fixed on a substrate;
wherein two or more pixels, of the plurality of pixels, each contain two or more additive process color areas, the two or more additive process color areas each comprising an opaque pigment, the two or more pixels each including a registration error that results in an overlap of a first additive process color area onto an adjacent second additive process color area;
wherein each additive process color area, of the two or more additive process color areas, has a centroid located within an area of the two or more pixels; and
wherein locations of the centroids, within the area of each of the two or more pixels, are present in two or more configurations in the plurality of pixels, the color image exhibiting a decreased color bias if compared to a comparative color image that is the same as the color image except that the centroids are present in a single configuration in the plurality of pixels.
